(19) United States
(12) Patent Application Publication
(10) Pub. No.: US 2025/0230107 A1
(43) Pub. Date: Jul. 17, 2025

(54) COMPOSITE COMPOSITION FOR PROMOTING GROWTH HAVING NATURAL SILICA EXTRACT AND BIOCHAR

(71) Applicant: SOLBIO CO., LTD., Okcheon-gun (KR)

(72) Inventor: Sol Bi KIM, Okcheon-gun (KR)

(73) Assignee: SOLBIO CO., LTD., Okcheon-gun (KR)

(21) Appl. No.: 18/288,033

(22) PCT Filed: Aug. 8, 2023
(86) PCT No.: PCT/KR2023/011636

§ 371 Date: Mar. 31, 2025

(30) Foreign Application Priority Data
Aug. 22, 2022 (KR) 10-2022-0104593

(51) Int. Cl. C05F 11/00

(52) U.S. Cl. CPC C05F 11/00

(57) ABSTRACT

The present invention relates to a composite composition for promoting growth having a natural silica extract and biochar, and more specifically, the present invention provides a composite composition for promoting growth comprising a natural silica extract and biochar, wherein the composition comprises: 30-45 parts by weight of a composition for promoting the activity of Actinomycete, which comprises a natural silica extract and biochar; 2-5 parts by weight of dietary fiber; 15-25 parts by weight of calcium oxide; 10-20 parts by weight of magnesium oxide; 3-10 parts by weight of iron; 0.01-1 part by weight of boron; 0.1-3 parts by weight of manganese; 0.5-3 parts by weight of zinc; and 0.0001-0.001 parts by weight of molybdenum.

According to the present invention, it effectively decomposes non-degradable organic materials and removes odor produced by antibiotics, prevents disease and insect pests, and uses biochar to promote the activity of Actinomycetes.

### CROSS REFERENCE TO RELATED APPLICATION

The present application claims priority to Korean Patent Application No. 10-2022-0104593, filed Aug. 22, 2022, the entire contents of which are incorporated herein for all purposes by this reference.

### BACKGROUND OF THE INVENTION

### Field of the Invention

The present invention relates to a composite composition for promoting growth having a natural silica extract and biochar and, more specifically, to a composite composition for promoting growth, which promotes the activity of Actinomycetes existing in the soil to decompose organic materials and to remove odors, prevent pests, and has excellent effects of killing harmful bacteria.

### Description of the Related Art

In general, Actinomycete is present as a mycelium and spore in soil, plants, animals, rivers, seawater, etc., and is widely distributed in the natural world, and in particular, it refers to Actinomycete present in soil because there are various types detected in soil and occupies most of Actinomycete present in the natural world.

The Actinomycetes detected in soil are classified into aerobic, anaerobic, thermophilic, mesophilic, Psychrophilic, non-pathogenic, parasitic, acid resistance, neutrophilic, and among them, those belonging to the aerobic, mesophilic, heterotrophic, non-pathogenic, neutrophilic group are the most, and usually millions of them exist per 1 g of soil, and among the soil, Actinomycetes play an important role in decomposition of various organic matter, particularly, in decomposition of non-biodegradable organic matter, and creating antibiotics to dominate other microorganisms.

The Actinomycete has functional diversity producing enzymes and metabolites exhibiting various activities, and particularly, secondary metabolites produced by Actinomycete are very diverse and rich in structure and function, and it is known that 75% or more of about 1000 kinds of known antibiotics are separated from Actinomycete, and about 64% of various bioactive substances such as anticancer agents, immunomodulators, useful enzymes, and the like, are derived from Actinomycete.

Actinomycetes can remove or reduce odor caused by fermentation of organic matter, and the odor is caused by nitrogen compounds, etc., which are generated in a process of fermentation of organic matter by organic matter, and specifically, ammonia (NH₃), hydrogen sulfide (H₂S), indole, mercaptan, scatol, volatile amines, and the like may be caused, and the odor is caused by a substance component that generates odor, and the irritating gaseous substance stimulates the human olfactory to cause discomfort or disgust, and such an odor problem disappears when the odor component itself is decomposed or removed, so a technology for selecting and removing microorganisms that decompose odor components is required.

The existing technology uses a method of promoting the use of Actinomycetes by using mineral-activated silica found in sand, rock, etc., but research on a method of preparing a fertilizer having an excellent Actinomycetes activity effect and an excellent decomposition effect of non-degradable organic matter is insufficient, and thus there is a need for research on a method capable of supplementing the same.

The natural silica is a silica manufactured by using extracts of rice bran, chaff, and large interior, can remarkably reduce metal components harmful to the human body by applying a refining process to by-products such as chaff, and the like, can reduce carbon footprints by 70% compared to mineral activated silica found in existing rocks, and the like, and biochar has recently been in the spotlight as a low-carbon agricultural technology, and particularly, has a function of providing a microbial residence, thereby being used as a material for activating Actinomycetes.

Accordingly, the present invention aims to develop a fertilizer composition and a manufacturing method therefor, wherein the composition for promoting the activity of Actinomycete, including natural silica extracts and biochar, can be used as a fertilizer composition, thereby having more excellent effects of decomposing non-degradable organic matter and removing odors generated by antibiotics when used as a fertilizer, and further promoting the activity of Actinomycetes, maintaining moisture, preventing diseases and harmful insects by using biochar, thereby promoting the apoptosis of harmful bacteria and the growth of plants.

### DOCUMENTS OF RELATED ART

(Patent Document 1) KR 10-1285792 B1 (Jul. 8, 2013)

### SUMMARY OF THE INVENTION

The present invention has been made in an effort to solve the above problems and, more specifically, to provide a composite composition for promoting growth including natural silica extracts and biochar having excellent effects of effectively decomposing non-degradable organic materials and removing odors produced by antibiotics, and having excellent antibacterial and plant growth promotion effects.

The present invention relates to a composite composition for promoting growth, comprising a natural silica extract and biochar.

The present invention provides a composite composition for promoting growth having a natural silica extract and biochar comprises: 30-45 parts by weight of a composition for promoting the activity of Actinomycete, which comprises a natural silica extract and biochar; 2-5 parts by weight of dietary fiber; 15-25 parts by weight of calcium oxide; 10-20 parts by weight of magnesium oxide; 3-10 parts by weight of iron; 0.01-1 part by weight of boron; 0.1-3 parts by weight of manganese; 0.5-3 parts by weight of zinc; and 0.0001-0.001 parts by weight of molybdenum.

In the present invention, the composition for promoting the activity of Actinomycete comprises biochar, a natural silica extract, water-soluble minerals, and chitosan at a ratio of 1:1:1:1.

In addition, the biochar is obtained by pyrolyzing biomass, and may have an average particle size of 20 to 200 micrometers and a porosity of 30 to 80%.

Here, the natural silica extract is a rice husk extract, and the rice husk extract is prepared through heat treatment.

In addition, the composite composition may further include an organic raw material.

In addition, the composite composition may include any one or a plurality selected from a residual pesticide remover, a nutritional additive, a thickener, a surfactant, a stabilizer, an antifoaming agent, a cryoprotectant, and a preservative.

The composite composition for promoting growth including the natural silica extract and the biochar according to the present invention effectively decomposes non-degradable organic materials and removes odor produced by antibiotics, prevents disease and insect pests, and uses biochar to promote the activity of Actinomycetes, maintain moisture, prevent disease and insect pests, and exterminate harmful bacteria and promote the growth of plants.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 illustrates a process of preparing biochar used as a composition for the activity of Actinomycetete according to the present invention.

FIG. 2 is a photograph showing the growth result of lettuce cultivated by the composite composition for promoting growth according to the present invention.

FIG. 3 is a photograph showing a ginseng field using the composite composition for promoting growth according to the present invention.

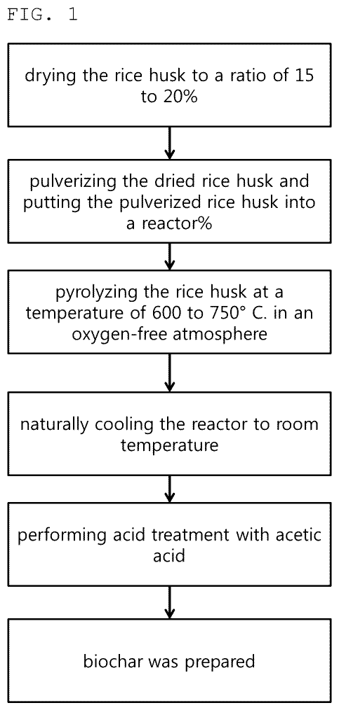

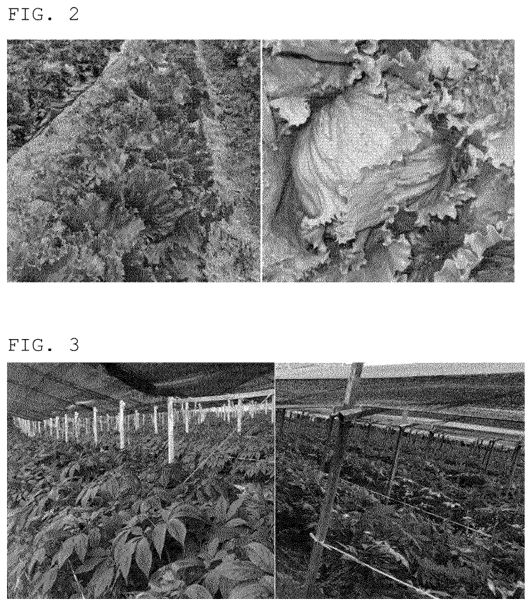

### DETAILED DESCRIPTION OF THE INVENTION

Hereinafter, a composite composition for promoting growth including the natural silica extract and the biochar according to the present invention will be described in more detail as specific examples. However, the following embodiments are provided as examples to sufficiently transfer the spirit of the present invention to a skilled person in the art.

Therefore, the present invention is not limited to the following embodiments, but may be embodied in other forms, and the following embodiments are only described to clarify the spirit of the present invention, and the present invention is not limited thereto.

In this case, unless otherwise defined in the technical terms and the scientific terms used, the technical terms and the scientific terms have meanings that are generally understood by those skilled in the art to which this invention belongs, and descriptions of known functions and features that may unnecessarily obscure the gist of the present invention will be omitted in the following description.

In addition, the singular form used in the specification and the appended claims may be intended to include a plurality of forms unless there is a special instruction in the context.

The composite composition for promoting growth having a natural silica extract and biochar according to the present invention comprises: 30-45 parts by weight of a composition for promoting the activity of Actinomycete comprising a natural silica extract and biochar; 2-5 parts by weight of dietary fiber; 15-25 parts by weight of calcium oxide; 10-20 parts by weight of magnesium oxide; 3-10 parts by weight of iron; 0.01-1 part by weight of boron; 0.1-3 parts by weight of manganese; 0.5-3 parts by weight of zinc; and 0.0001-0.001 parts by weight of molybdenum.

The biochar is a solid obtained by pyrolyzing biomass at a high temperature in a range of about 200 to 1,000° C. in an oxygen-free or low-oxygen environment, and the biomass may include terrestrial biomass including wood, sawdust, and the like, and marine biomass including marine algae and the like. The raw material of the biochar is not limited, but it is preferable to use rice husk, which is agricultural waste.

According to an exemplary embodiment of the present invention, the biochar is not particularly limited in size and shape, but may be prepared and provided in various shapes such as powder, pellet, and cake.

According to an exemplary embodiment of the present invention, the biochar is not particularly limited in terms of particle size, but may have a particle size based on 4 to 400 mesh ASTM, preferably a particle size based on 20 to 200 mesh ASTM, but is not limited thereto. When the particle size is satisfied, the efficiency of Actinomycetes can be further increased when compared to when coupled to natural silica for use alone, the antibacterial property can be improved when coupled to chitosan, and the adsorption properties of bacteria or harmful substances are excellent.

In addition, when the biochar is activated by acid treatment, the surface area and pore volume are remarkably increased, thereby maximizing the performance of biochar, and it is preferable to perform acid treatment using acetic acid, and the biochar acid treatment may be performed together with an acid treatment process used in extracting the natural silica.

According to an exemplary embodiment of the present invention, the biochar may have a porosity of 40 to 80%, a pore size of 0.01 to 2 micrometers, and an adsorption pore volume of 0.001 to 0.5 cm²/g, but may not be limited thereto. In the case of having the pore characteristics in the above range, it is preferable that natural silica is sufficiently bonded, the adsorption characteristics of biochar are maximized, and the effect of Actinomycetete activity can be remarkably improved by providing a microbial habitat.

Also, the biochar can improve soil moisture retention ability, can be used together with the natural silica extract to reduce the amount of fertilization or the number of fertilization, and can promote plant growth.

In the present invention, the composition for promoting the activity of Actinomycete comprises biochar, a natural silica extract, water-soluble minerals, and chitosan at a ratio of 1:1:1:1.

In addition, compared with a case using the composition for promoting the activity of Actinomycete, which comprises a natural silica extract, water-soluble minerals, and chitosan at a ratio of 1:1:1, when further comprising biochar, the natural silica extract, water-soluble mineral, and chitosan at a ratio of 1:1:1:1, the action time of sterilization and insecticidal action is longer when spraying the composition on soil, the period for preventing disease and insect pest is lengthened, and a range applied regardless of the environment according to the temperature change or the moisture change is wide, thereby further enhancing the effect of preventing disease and insect pest. This is because biochar is provided as a microbial habitat, so it has excellent anti-microbial activity and maintenance ability and easy to maintain moisture.

Further, as the composition for promoting the activity of Actinomycetes, the natural silica extract is preferably used as a rice husk extract, and the rice husk extract is preferably used in the form of an extract. The use of the rice husk powder leads to little or no odor removal or reduction effects, but the use of the rice husk extract after purification may lead to better odor removal effects.

The natural silica extract is natural silica extracted by refining the shell of rice, which is a by-product to be discarded, and increases Actinomycetes and decomposes non-biodegradable organic materials and removes or reduces odors produced by antibiotics.

The rice husk extract may be prepared by mixing the rice husk with an acid solution such as acetic acid and the like through a pretreatment process and then, boiling the mixture at 95° C. to remove metal impurities and dissociate a portion of the intermolecular bonds in the rice husk. It is preferable to use a product prepared by washing the rice husk mixed with the acid solution, dehydrating under pressure, drying the rice husk at 100° C. to evaporate moisture, heat-treating the rice husk at 600° C., and pyrolyzing the cellulose and lignin components included in the rice husk at a high temperature.

In the acid solution mixed solution, the acid solution may have a concentration of 5 to 20 wt %, and the rice husk and acid solution may be present in a weight ratio of 1:20.

Further, the composition for promoting the activity of Actinomycete includes Actinomycete, wherein the Actinomycete is Streptomyces griseus, and the Actinomycete may be included in the composition for promoting the activity of Actinomycete at a volume ratio of 1:25 to 1:10. In this case, the rice husk extract is prepared through heat treatment.

The Actinomycetetes are preferably the genus Nocardia, the genus Streptomyces or the genus Thermoactinomyces, more preferably the genus Streptomyces, even more preferably Streptomyces aureofaciens, Streptomyces griseus, Streptomyces venezuelae, or Streptomyces olivaceus of the genus Streptomyces, and most preferably, Streptomyces griseus.

However, the Actinomycetes used in the present invention exclude pathogenic to animals and plants for example, Mycobacterium tuberculosis, which is a tuberculosis bacterium, and Streptomyces scabie, which is a potato dedengue bacterium, from the present invention.

In addition, the present invention may further include at least one microorganism selected from the group consisting of Saccharomyces cerevisiae, lactobacillus, Rhodobacter sphaeroides, and filamentous fungi as well as Actinomycete Bacillus.

In addition, as the composition for promoting the activity of Actinomycete, the water-soluble minerals may be included together with natural silica extracts and chitosan as biochar and active silica.

The water-soluble mineral may include about 10 to about 15 parts by weight based on 100 parts by weight of the composite composition.

When the water-soluble mineral is included in an amount of less than 10 parts by weight, various effects of the water-soluble mineral may not be sufficiently exhibited, and when the water-soluble mineral is included in an amount of more than 15 parts by weight, the water-soluble mineral causes excessive absorption of phosphoric acid, potassium, calcium, and the like as an excessive symptom, thereby hindering growth. The water-soluble minerals may be water-soluble silicic acid.

The water-soluble mineral-minerals promote root growth, cell tissue differentiation, floral differentiation and enable the capability of controlling body temperature under adverse conditions of weather changes.

The water-soluble mineral has a function of suppressing excessive nitrogen absorption, but is involved in RNA and DNA in cells and when pathogens invade, the water-soluble minerals release self-defense materials to produce allerpathic materials such as phenolics composite and pathotoxin, thereby preventing the invasion of pathogens.

It is preferable that the composition for promoting the activity of Actinomycetes includes biochar, a natural silica extract, water-soluble minerals, and chitosan in a ratio of 1:1:1:1. When the natural silica extract is combined, the composition for promoting the activity of Actinomycete is more effective in removing odor than when using the water-soluble minerals and chitosan as the composition for promoting the activity of Actinomycete; when the natural silica extract extracted by purifying the rice husk which is an discarded by-product is used, the rice husk, which is a waste resource, can be reused; when compared with when using only the mineral silica and chitosan, the activity of Actinomycete is further increased; being combined with the bio-error to maintain the increased activity of Actinomycete; being less affected by external environmental changes such as temperature or moisture environment; and further increasing the activity of Actinomycete.

The organic waste resources contain a large amount of organic materials and components required for the growth of crops so that, when the organic materials are used as fertilizers, odors are generated thereby tend to be reluctant to use the same although exhibiting excellent performance as fertilizers, but Actinomycetes may be activated and offensive odors may be reduced through the composition for promoting the activity of Actinomycete, and thus may be reused as fertilizer.

The composition for promoting the activity of Actinomycete may include chitosan.

The chitosan is for activating an immune vaccine of plant cells by chitin quality and producing chitin degrading enzymes in plant cells, and the chitosan is a polysaccharide polymer material formed by a myriad of binding units of a unit whose acetyl group has been removed from chitin.

The chitosan is a cationic natural polymer which is present in abundance next to cellulose in a natural state, and has a molecular structure very similar to that of cellulose, but has various physicochemical characteristics due to an amino group (—NH₂) in the molecule.

The chitosan can be obtained by deacetylating chitin extracted from crabs which are the crustaceans of the sea, the shell of shrimp, bones of squid which are the residue, and the like, and the main ingredient is polyglucosamine, which is a colorless amorphous powder having a polymer structure and exhibits effects such as antibacterial properties, antifungal properties, heavy metal adsorption, bioactivity, human affinity, wound healing promoting effects, and the like, and thus acts as an excellent natural antibacterial agent.

Because of this effect, the chitosan can inhibit the occurrence of plant pests, inhibit the propagation of mold in the soil, and promote physiological activation, while at the same time promoting the growth and increasing disease resistance when leaf surface spreading and making leaf surface spreading better, and can obtain the effects of promoting implantation, inhibiting disease and improving the storage properties of fruits and vegetables when flowering.

Also, the extract of the present invention has the effects of discharging heavy metals and feces from the human body or lowering blood cholesterol, thereby preventing adverse effects on the human body caused by seaweed contaminated with heavy metals. Therefore, the extract of the present invention can be used as feed as well as a fertilizer.

The chitosan may further include Trichoderma harzianum and marine algae which is a dietary fiber.

The Trichoderma harzianum are symbiotic with plant roots, produce various enzymes such as chitin degrading enzymes and hormones in the root region of the root, and secrete hormones capable of promoting the growth of plants, and may be used without particular limitation as long as they belong to the genus Trichoderma harzianum. Specific examples thereof include Trichoderma harzianum geno 1001, Trichoderma harzianum T-35, Trichoderma harzianum T-315, Trichoderma harzianum GBF-0208 strain and the like, and preferably, use of Trichoderma harzianum geno 1001 strain can greatly improve plant disease control effects when mixed with chitosan, can have excellent root access blocking and removal abilities of pathogenic fungi, and can have excellent root foot inducing and growth promoting effects.

Chitosan and Trichoderma harzianum produce Chitinase to dissolve cell walls of pathogenic fungi, and may secure Fusrium, which is causative bacteria of Pythium root rot of roots, stems, cells, etc., of plants, and Rhizoctonia solani which is causative bacteria of root rot, Phytophthora, Anthrax bacillus, Downy mildew, powdery mildew, fungi, etc., through organic matter.

The chitosan may be classified into a high molecular chitosan, a medium molecular chitosan, and a low molecular chitosan according to molecular weight, and may be classified into a water-soluble chitosan and a non-water-soluble chitosan according to water-soluble properties.

Accordingly, the chitosan used in the present invention preferably has a low molecular weight of water-soluble chitosan, more preferably has a molecular weight of 5 kDa (kilodalton) or less, a degree of deacetylation of 85% or more, and most preferably has a molecular weight of 3 to 5 kDa, a degree of deacetylation of 98% or more.

The low molecular weight chitosan is mostly dissolved in water, the non-dissolved powder is completely dissolved in an acidic condition by lactic acid which is a product of fermenting lactic acid bacteria in a mixture, and the chitosan is absorbed into plants, and the chitosan is preferably included in an amount of 10 to 15 parts by weight based on 100 parts by weight of the total composite composition.

In addition, the composite composition for promoting growth of the present invention may comprise saponin.

The saponin is commonly referred to as ginsenoside, which is named to mean a glyco-side separated from ginseng to distinguish it from saponin of other plants. There are 30 types of ginsenosides, and a wide variety of effects are known, including antioxidative effects, immune enhancement, arteriosclerosis and hypertension prevention, and anti-inflammation.

In addition, ginsenoside is contained in a large amount in by-products such as stems and leaves as well as roots of ginseng, and it is known that ginseng roots contain 4.45%, ginseng leaves 12.8 to 18.7%, ginseng flower 6.9%, ginseng fruit 6.68%, ginseng stem 1.6 to 2.39%, and ginseng seed 3.3%, which are 2 to 4 times more saponins than ginseng roots, such as ginseng leaves, flowers, and stems.

Since it contains a large amount of saponins or ginsenoside, which is a kind of saponins, it has an excellent advantage in preventing or treating diseases of plants.

The saponin is preferably contained in an amount of 3 to 10 parts by weight based on 100 parts by weight of the total composite composition.

The calcium oxide supplies calcium required for growing farm products and neutralizes acidic soil to correct soil reaction, thereby promoting activities of soil microbes and improving soil environment suitable for plant growth. Specifically, the calcium oxide is included in an amount of 15 to 25 parts by weight based on 100 parts by weight of the total composite composition. When the calcium oxide is included in an amount of less than 15 parts by weight, the effect of addition is insignificant, and when the calcium oxide is included in an amount of more than 25 parts by weight, the effect of promoting plant growth may be rather lowered.

Even if calcium exists in the soil, it is limited to absorption or accumulation depending on the condition or environmental conditions of the soil, resulting in physiological disorders due to lack of calcium and weakening resistance to diseases.

The calcium oxide is distinguished from calcium carbonate, and the calcium oxide may be formed by sintering the eggshell calcium and the shell calcium. Calcium oxide is difficult to dissolve in water and is mostly precipitated and difficult to easily absorb in plants, but when the shell is used after sintering, making it an aqueous calcium hydroxide solution, and alkali-stabilizing, it is possible to increase calcium deficiency, resistance to disease and the ability to store fruit even in small amounts.

When using eggshells of various birds that are dissolved in an organic acid such as acetic acid, etc., and then sintered, and microwave-irradiated, the eggshell calcium has excellent resistance against a bottle and a fruit storage capacity compared to a conventional calcium carbonate obtained from limestone, etc.

The shell calcium may be prepared by washing and drying shells, pulverizing the shells, putting the shells in a furnace, firing the shells at 1, 500 to 1, 800° C. to remove carbon dioxide from the shells, and irradiating microwaves to reform the shells. In the case of the microwave-irradiated calcium oxide is used after the sintering, the same effect may be obtained in a smaller amount than when general calcium carbonate obtained from limestone is used. However, since calcium may be destroyed if the microwave irradiation time is prolonged, it is preferable to have 0.1 to 2 minutes at 2,450 MHz.

When using shell calcium that is washed, dried, pulverized, and sintered, and microwave-irradiated, as an aqueous solution, it has the same excellent effect as when the aqueous solution of calcium shell is used. In addition, the use of eggshell calcium and shell calcium has better dissolution and absorption than the use thereof alone. In addition, the weight ratio of the eggshell calcium and the shell calcium is preferably 1:0.3 to 1:0.7, and more preferably 1:05.

When included in the weight ratio, an unpredictable synergistic effect occurs between the components, and thus it may be advantageous for fruit storage power and plant growth.

The magnesium oxide (MgO) is included for the purpose of increasing the plant absorption rate of phosphorous acid included in the present invention and promoting plant growth, together with the alkalization of acidic soil. Specifically, the magnesium oxide is included in an amount of 10 to 20 parts by weight based on 100 parts by weight of the total composite composition. When the magnesium oxide is included in an amount of less than 10 parts by weight, the effect of adding the magnesium oxide is insignificant, and when the magnesium oxide is included in an amount of more than 20 parts by weight, the effect of promoting plant growth may be rather deteriorated.

The boron and the molybdenum are water-soluble boron and water-soluble molybdenum, and the water-soluble boron is closely related to absorption and use of calcium, is involved in pectin formation of a cell membrane, and is involved in water metabolism and current of saccharide.

The water-soluble boron is included in an amount of 0.01 to 1 part by weight, preferably 0.05 part by weight.

When the water-soluble boron is included in an amount of less than 0.01 parts by weight based on 100 parts by weight of the total composite composition, there is a concern that a deficiency may occur in the neotissue of the plant, the conducting tissue may deteriorate, the leaves may shrink, and the cell membrane may be destroyed, and the browning-dead may occur. When the water-soluble boron is included in an amount greater than 1 part by weight, a large amount of saccharides may be accumulated in the leaves to increase osmotic pressure, thereby increasing the water retention capacity, and thus, the amount of moisture to be increased from the leaves may be reduced, thereby hindering moisture metabolism.

The water-soluble molybdenum is a growth control material for inducing crop growth, and has a function of improving nutrient and moisture absorption of crops by an excellent root improvement effect and preventing pests from aphid, nematodes, etc.

The water-soluble molybdenum may be included in an amount of 0.0001 to 0.001 parts by weight, preferably 0.0005 parts by weight, based on 100 parts by weight of the total composite composition.

When the content of the water-soluble molybdenum is less than 0.0001 parts by weight, the above-described effect of the water-soluble molybdenum may not be exhibited, and when the content of the water-soluble molybdenum is more than 0.001 parts by weight, there is a problem in that the hypertrophy phenomenon of the plant occurs.

The dietary fiber component may specifically be marine algae, and may include green algae, brown algae, and red algae. As a specific example, the green algae may be any one or two or more selected from green laver, seaweed fulvescens, Codium fragile, laver, and the like; the brown algae may be any one or two or more selected from seaweed, kelp, sargassum, Hizikia fusiformis, sea oak, Sea trumpet, and the like; and the red algae may be any one or two or more selected from laver, Ceylon moss, Gloiopeltis tenax, Carrageenan, and the like.

The marine algae includes various functional components such as taurine, n-3 fatty acid, alginic acid, fucoidan, laminarin, pectin, and the like, which can exhibit physiological activity, as well as dietary fiber, vitamins, minerals.

Preferably, the marine algae may be kelp having a high inorganic content, seaweed, and the like, and in seawater, dozens of trace elements such as calcium, potassium, magnesium, iron, iodine, phosphorus, and the like, and various enzymes are dissolved, and the enzyme may decompose plankton in the seawater, carcasses of fish and shellfish, and the like to generate an organic material, and the organic material may be a nutrient for growing marine algae.

In addition to various pigments such as carotenes, xanthophylls, and chlorophyll, kelp contains a lot of carbohydrates such as mannitol and laminarin, which are made by carbon anabolic effects, and alginic acid, which is a component of the cell wall, and also contains amino acids such as iodine, vitamin B2, and glutamic acid, and in particular, kelp is a good material for supplying inorganic salts because it contains a lot of inorganic salts such as iodine, potassium, and calcium.

Seaweed is marine algae falling under brown algae, and is an alkaline material that is rich in inorganic substances such as potassium, calcium, magnesium, strontium, phosphorus, iodine, sulfur, and the like, dietary fiber, linoleic acid, vitamins, etc., and contains a lot of bioactive materials.

Fucoidan contained in seaweed and kelp is a sulfated polysaccharide with a sticky mucous structure, which is combined with a basic sugar called fucose and a sulfuric acid group, and is known as a basic raw material for functional foods, dietary supplements, and additives because it has been found to have anti-coagulant activity, anti-tumor activity, gastric ulcer treatment promotion activity, anti-microbial activity, anti-blood pressure enhancement suppression activity, hepatocyte growth factor (HGF) production induction, blood glucose enhancement suppression activity, immune cell regulation activity, anti-allergy activity, and antiviral activity.

The iron acts as a catalyst for the production of chlorophyll, plays a role of oxygen transport, an enzyme activator and a hydrogen peroxide decomposing agent, and when iron is deficient, chlorophyll is not synthesized and thus leaves cannot maintain blue color and yellows occur.

The manganese or the zinc is involved in the growth and maturation of plants and plays a role as a coenzyme, and if they are insufficient, it interferes with biochemical synthesis and degrades the nutritional value of the plants themselves.

In addition, the present invention may further include an organic raw material.

The organic raw material is a raw material containing nitrogen, phosphoric acid, or the like, included in the fertilizer, and may include a food by-product, a by-product remaining after being trimmed with a medicine, or the like, or the like.

The organic raw material may include, for example, food and beverage by-products such as ginseng tea, green tea, and red tea, ginseng by-products such as ginseng leaves and ginseng stems, and ginseng by-products such as ginseng berry, and the like, and may also include general food, fat (oil), agricultural waste, and the like.

Particularly, tea such as green tea, red ginseng tea, yellow tea and ginseng tea is the by-product of tea bags and comprises polyphenols such as catechin and flavonol, terpenes, free amino acids, vegetable alkaloids, vitamins such as provitamin A, vitamin B group, vitamin C, vitamin E and vitamin P, and minerals such as potassium, phosphorus, magnesium, zinc and manganese, thereby suppressing plant diseases and supplying nutrients to the soil, and, the fermented product can be produced to reduce the molecular weight thereof through fermentation and supply nutrients to the plants for a long time.

In particular, ginseng leaves, ginseng stem, ginseng fruit, ginseng tea, etc., which are made of ginseng by-products, have an excellent advantage in preventing or treating plant diseases because they contain a large amount of saponins, which are pharmacologically active ingredients, or ginsenoside, which is a kind of saponins, in the raw ginseng. In addition, ginseng tea is prepared from peduncles, leaves, stems, fruits, flesh, ginseng seedlings, etc., which are products not processed in farms, other than roots generally used in oriental medicine, and contains a large amount of active ingredients, thereby enabling the supply and demand of raw materials at low prices and having an eco-friendly advantage by recycling discarded by-products.

In addition, the organic raw material may further include any one or a plurality of supplementary raw materials selected from green tea, Amaranthus ssp L., Solanum lyratum Thumb., Ginkgo biloba L., white tea, black tea, green tea, motherwort, Cyperus rotundus Linne, Asian lizard's tail, mugwort, white Saponaria, lemon balm, chamomile, rosemary, peppermint, eucalyptus, tea tree, rose hip, chamomile, rosemary, lavender, geranium, rosewood and neroli in addition to the ginseng tea.

The above components are added in order to increase the content of active ingredients such as polyphenol, free amino acid, and the like, in addition to the above-mentioned pharmacologically active ingredients, and simultaneously, to increase antibacterial effects, insect-repellent effects, and the like, and particularly, it is preferable to add any one of Ginkgo biloba L., Amaranthus ssp L., Solanum lyratum Thumb., and the like, or a mixture thereof, to the above-mentioned ingredients.

The Ginkgo biloba L. is a fruit of the ginkgo family, and contains a small amount of the dividend of cyanogenic glycosides and gibberellin, cytokines, ginkgelic acid, hydroginkgolic acid, hydroginkgolinic acid, bilobol, ginnol, asparagine, formic acid, propionic acid, lactic acid, octanoic acid, nonacosanol-10, etc., and particularly, ginkgelic acid acts as an insect repellent, and thus, when used as a fertilizer, it can suppress the growth interference of crops caused by pests.

The Amaranthus ssp L. is a year-old plant belonging to the Amaranthaceae, and is called pigweed, and the like, and is mainly used as a dye. In addition, the present invention is rich in organic substances such as calcium, iron, phosphorus and the like, and organic substances such as taurine and the like, and, in particular, has an increased polyphenol content when fermented, and, when mix and use with above mentioned Ginkgo biloba L., cyanide such as Ginkgo biloba L. and Solanum lyratum Thumb. are decomposed while anti-bacterial, insect-repellent effects are increased.

The Solanum lyratum Thumb. is a vine plant of Solanaceae family of Solanaceae, and is called by various names such as Baekmodeung, Chokyangcheon, Baekyoung, Gwamokcho, and Baekcho. Since the entire plant contains alkaloids such as tomatidenol, solasodine, and soladulcidine, it has excellent antibacterial and insect-repellent effects.

The above ingredients have antibacterial and insect-repellent effects as described above, and particularly, when all the above ingredients are mixed and used, the above-described pharmacological effects and the effect of further increasing the absorption rate of the active ingredients of the crops compared to the case of adding the ingredients alone.

In the case of using the mixture of the Ginkgo biloba L., the Amaranthus ssp L., the Solanum lyratum Thumb., and the like, a mixing ratio thereof is not limited, but it is preferable to use the mixture of the Amaranthus ssp L., the Ginkgo biloba L., the Solanum lyratum Thumb., and the like in a weight ratio of 1:0.1 to 0.5:0.1 to 0.5. If the above range is out of the above range, the degradation of the cyanide such as solanine or amygdaline contained in the Ginkgo biloba L., the Solanum lyratum Thumb., etc., is insufficient, and thus it may adversely affect the crop. In addition, when mixing with the ginseng tea or the like and using it, it is preferable to mix 1 to 10 parts by weight of the sub-raw material based on 100 parts by weight of the organic raw material to achieve the above-described effect.

In addition, the organic raw material may further include fruit flesh of fruits such as peaches, apples, kiwis, plums, watermelons, tangerines, oranges, lemon, grapefruit, quince, citrus fruit, etc., and oil-seed meals such as rice bran, steamed silkworm chrysalis oil-seed meals, rice bran oil-seed meals, soybean meals, cotton seed meals, sesame pulp, etc., as an amino acid source.

In addition, the above-described organic raw material may be a pretreated organic raw material prepared by heat-treating the same at a temperature of 80 to 300° C. for 0.1 to 3 hours, and the pretreated organic raw material may be an organic raw material which inhibits the growth of various bacteria during fermentation by exterminating microorganisms through heat treatment, enables short-term fermentation by inducing mechanical decomposition of tissues such as cell walls, and exhibits homogeneous fermentation performance.

The sawdust is a buoyant agent which improves the productivity and moisture absorption of a fertilizer and helps organic nitrification fermentation, and when sawdust is added, the fermentation rate of a composition is increased and the degree of fermentation is increased, thereby obtaining excellent quality organic fertilizer.

The material of the sawdust is not limited, but it is preferable to use sawdust made from pine as a raw material. The pine sawdust as described above is a wood by-product, which helps the growth of microorganisms and is known to have an excellent effect on the growth of plants. The pine tree is a residue of wood such as a damaged wood residue at a road construction site or the like, a branch generated during logging, pine tree nematodes, and harmful insects, and may be mixed with the easily cultured soil composition by using the pine tree as sawdust.

The pine trees collectively refer to the trees of pinales, and, as trees of pinales, a family Pinaceae including a Abies holophyll, a Abies firma, a Abies nephrolepis, a Picea jezoensis, a Picea abies, a Pinus koraiensis, a Pinus densiflora for. multicaulis Uyeki, a Pinus densiflora, a Pinus thunbergii, etc.; a family of Taxodiaceae including a Metasequoia, a Taxodium distichum, a Cryptomeria japonica, etc.; a family Cupressaceae including a Platycladus orientalis, a Chamaecyparis obtusa, a Juniperus chinensis, a Juniperus rigida, etc.; and trees of pinales belonging thereto may be collectively referred the same.

In addition, the sawdust may be used by immersing the sawdust in hydrogen peroxide (H₂O₂) washing water diluted with 1,000 times for 10 hours or more, washing and drying the same to remove harmful microorganisms and larvae (nematodes) and eggs inside.

The amount of sawdust added is not limited, but is preferably 10 to 100 parts by weight based on 100 parts by weight of the organic raw material. When the content of sawdust is less than the above range, it is not possible to obtain a desired plant growth and growth rate because the supply of nutrients is insufficient, and when the content is more than the above range, decomposition may be excessively generated in the process of preserving the composition or harmful microorganisms may proliferate.

The saccharides are added to promote fermentation by the strain, and may be used regardless of the kind of carbohydrate that is generally well dissolved in water and has a sweet taste. The saccharides are divided into monosaccharides, disaccharides, and polysaccharides, and may include sugar, oligosaccharides, glucose, starch syrup, black sugar, molasses, or a mixture thereof.

The saccharide is preferably added in an amount of 10 to 200 parts by weight based on 100 parts by weight of the organic raw material. When the saccharide is added below the above range, fermentation may not be properly performed, and when the saccharide is added above the above range, harmful components due to the fermentation of the saccharide may be generated, and thus the above-described effects may be reduced.

In addition, the composite composition of the present invention may further include any one or a plurality of additives selected from a residual pesticide remover, a nutritional additive, a pesticide, a thickener, a surfactant, a stabilizer, an antifoaming agent, an antifreeze agent, and a preservative, in addition to the organic raw material.

Specifically, the residual pesticide remover is mixed with the porous ceramic powder to more effectively remove the pesticide component remaining in the soil.

For example, the residual agrochemical removing agent may be titanium dioxide (TiO₂), zinc oxide (ZnO), aluminum oxide (Al₂O₃), nickel oxide (NiO), nickel chloride (NiCl₂), or a mixture thereof, and such a component is introduced into the soil to serve as a catalyst for removing the residual agrochemical component and assists with the porous ceramic powder to more effectively remove the agrochemical component in the soil.

The nutritional additive is used to promote crop growth by forming a natural organic complex providing essential components for crop growth in the soil due to natural chemical and biological effects by being supplied to the soil, and for example, humic acid, fulvic acid, guano granular, algae extract, or a mixture thereof may be used.

More specifically, when the humic acid is introduced into the soil, it is possible to form a natural organic composite in the soil due to natural chemical and biological effects, promote root roots, and increase the bearing capacity of the soil.

Fulvic acid may promote nutrient absorption, energy metabolism, enzyme activity, cell membrane penetration, and root embryogenesis. In addition, the present invention chelates cations contained in the soil, which results from high cation substitution ability, so as to have electrostatic repulsion between soils, and thus, as the soils adsorb and gradually elute visible fertilizers from among the soils together with the functional property of sponging the soil, the salts in the soil are removed, the salt stress that exert the effect of slow- and controlled-release-fertilizer are alleviated, and the RNA synthesis of crops is enhanced, thereby promoting rooting and growth and allowing the roots of the crops to be firmly and deep.

In particular, when fulvic acid and humic acid are simultaneously introduced into general soil, salts in the soil neutralize the negative charge on the surface between clay particles, thereby removing the repulsive force between the particles. On the other hand, when the fulvic acid-injected soil dissociates salt and is separated from the surface of the clay particle, the clay particle becomes negatively charged, and thus a repulsive force acts between each other, thereby loosening the structure of the soil. In other words, it solves the density of soil and enhances ventilation and drainage.

Guano is a natural fertilizer derived from the excrement of algae in the dry area of South America, contains three major components of nitrogen, phosphoric acid, and a family and organic materials, and can be provided to the soil including effective minerals such as calcium, magnesium, iron, sulfur, manganese, copper, and iodine.

The algae extract is prepared using kelp, which is a natural resource of the sea, and thus contains a large amount of natural plant hormones and natural minerals, thereby having excellent effects in promoting crop growth. Also, soil is formed into a complex by alginic acid, which is a polymer polysaccharide contained in a large amount, thereby improving air permeability and water drainage.

The insect repellent of the present invention is provided to strengthen insecticidal, insect-repellent and disinfectant properties, and is mainly prepared by using natural vegetable raw materials containing a large quantity of alkaloid components such as rotenone, matrine and the like, pyrethroids such as pyrethrine and the like, azadilactin, acidic components, and taric components such as phenolic acid and the like.

For example, the insect repellent may include a pyroligneous acid, a clove extract, castor oil, a Toxicodendron vernicifluum extract, a Derris extract, a bittersweet extract, a Tanacetum cinerariifolium extract, a Phryma leptostachy extract, a Pelargonium graveolens extract, a Sophora flavescens extract, a Melia azedarach L. extract, a Azadirachta indica extract, a Meliae fructus extract, acetic acid, or a mixture thereof.

In addition, the additive may further include an auxiliary additive including a thickener, a surfactant, a stabilizer, a defoamer, an anti-freezing agent, a preservative, or a mixture thereof in order to improve physical properties such as storage stability, stability, anti-freezing, and preservability, and a component commonly used for preparing a fertilizer and a liquid may be introduced. For example, the additives may be added in an amount of 0.1 to 10 parts by weight based on 100 parts by weight of the organic raw material.

The present invention is environmentally friendly because it does not contain chemical fertilizers or organic synthetic pesticides, and is outstandingly effective in preventing bad smells and crop damage, strengthening antimicrobial properties and promoting growth.

The composite composition may be used in a liquid or solid form.

Hereinafter, the present invention will be described in more detail with reference to examples and comparative examples. However, the following Examples are only specific examples for describing preferred embodiments of the present invention, and the present invention is not limited by the following Examples.

### EXAMPLES

### Example 1

A composite composition was prepared by mixing 35 parts by weight of composition for promoting the activity of Actinomycete, 3 parts by weight of dietary fiber, 20 parts by weight of calcium oxide (shell calcium), 15 parts by weight of magnesium oxide, 5 parts by weight of iron, 0.05 parts by weight of boron, 1 part by weight of manganese, 2 parts by weight of zinc, and 0.0005 parts by weight of molybdenum, wherein the Streptomyces activity promoting composition was prepared by mixing biochar, a rice husk extract, water-soluble minerals and chitosan at a ratio of 1:1:1:1 and adding strotomyces griseus to the remainder as Streptomyces; the biochar was prepared by drying the rice husk to a ratio of 10 to 20%, pulverizing the dried rice husk, putting the pulverized rice husk into a reactor, and then pyrolyzing the rice husk at a temperature of 600 to 750° C. in an oxygen-free atmosphere; and naturally cooling the reactor to room temperature, and then performing acid treatment with acetic acid to have an average particle size of 100 μm and a porosity of 60%.

### Example 2

The same composite composition as that of Example 1 was prepared, except that as the composition for promoting the activity of Actinomycete, biochar, rice husk extract, water-soluble minerals, and chitosan were included in a weight ratio of 0.5:0.5:2:2.

### Example 3

A composite composition was prepared in the same manner as in Example 1, except that biochar had an average particle size of 400 μm and a porosity of 10%, as the composition for promoting the activity of Actinomycete.

### COMPARATIVE EXAMPLES

### Comparative Example 1

The same composite composition as in Example 1 was prepared except that biochar was excluded from the composition for promoting the activity of Actinomycete.

### Comparative Example 2

The same composite composition as that of Example 1 was prepared except that the rice husk extract was excluded from the composition for promoting the activity of Actinomycete.

### Comparative Example 3

The same composite composition as that of Example 1 was prepared except that the composition for promoting the activity of Actinomycete was included in 10 parts by weight.

The performance of the composite composition samples prepared according to Examples and Comparative Examples was measure d as follows.

### Experimental Example 1

Compost used as a filter in a prefabricated small warehouse was applied to the bottom at a width of 1.0 m x, a length of 1.0 m x, and a height of 10 cm, and the composite compositions ac cording to Examples and Comparative Examples were mixed with the soil on the ground. And the intensity of the odor was investigated at 1 p.m. for 14 days on 10 panels trained on the odor. For odor testing, the interior of the warehouse was sealed to avoid ventilation. In addition, the case in which the odor is very strong is set to 5 points, and the case in which there is no odor is set to 0, and an average value thereof is calculated and then the results are shown in Table 1 below.

TABLE 1

| | Example | Example | Example | Comparative | Comparative | Comparative |
|---|---|---|---|---|---|---|
| Category | 1 | 2 | 3 | Example 1 | Example 2 | Example 3 |
| Odor | 0.8 | 1.0 | 1.2 | 2.3 | 3.5 | 1.4 |
| evaluation | | | | | | |

The compositions prepared by Examples and Comparative Examples were put into a chamber in an ammonia atmosphere by 8 g, sealed, and the ammonia concentration according to the change in time was measured, and the results are shown in Table 2.

TABLE 2

| | Residual ammonia concentration | | | | | |
|---|---|---|---|---|---|---|
| time | Example | Example | Example | Comparative | Comparative | Comparative |
| (minutes) | 1 | 2 | 3 | Example 1 | Example 2 | Example 3 |
| Initial | 500 | 500 | 500 | 500 | 500 | 500 |
| stage | | | | | | |
| 30 | 62 | 71 | 69 | 126 | 460 | 150 |
| 60 | 34 | 42 | 40 | 86 | 430 | 102 |
| 90 | 21 | 31 | 29 | 62 | 410 | 76 |
| 120 | 13 | 20 | 18 | 45 | 400 | 50 |

The fertilizers produced by Examples and Comparative Examples were soil sprayed on peppers, leaf surfaces fertilized and irrigation fertilized, respectively.

The soil spraying was performed by uniformly spraying 30 g of the fertilizer per 3.3 m² to the soil 1 month before the red pepper equation, and the effect of the red pepper cultivation was evaluated by a method of evaluating the red pepper yield per unit area (kg/10a) by further adding the fertilizer after the red pepper equation and performing foliar treatment, and the results are shown in Table 3 below. At this time, the one that did not fertilize the fertilizer was evaluated together as a control group.

TABLE 3

| Category | Yield | Number of required applications |
|---|---|---|
| Example 1 | 334 | Five times |
| Example 2 | 308 | Five times |
| Example 3 | 303 | Five times |
| Comparative Example 1 | 211 | Five times |
| Comparative Example 2 | 189 | Five times |
| Comparative Example 3 | 282 | Five times |
| Control group | 160 | — |

The fertilizers prepared by Examples and Comparative Examples were treated with foliar and irrigation, respectively, and the incidence (%) of plague and anthrax was investigated, and the results are shown in Table 4 below. At this time, the one that did not fertilize the fertilizer was evaluated together as a control group.

TABLE 4

| | | Anthrax incidence |
|---|---|---|
| Category | Plague generation rate | rate |
| Example 1 | 1.7 | 1.8 |
| Example 2 | 2.4 | 2.9 |
| Example 3 | 2.1 | 2.6 |
| Comparative Example 1 | 4.7 | 8.9 |
| Comparative Example 2 | 6.1 | 9.1 |
| Comparative Example 3 | 3.9 | 5.3 |
| Control group | 14.6 | 16.2 |

What is claimed is:

1. A composite composition for promoting growth having a natural silica extract and biochar, wherein the composition comprises,
30-45 parts by weight of a composition for promoting the activity of Actinomycete comprising a natural silica extract and biochar;
2-5 parts by weight of dietary fiber; 15-25 parts by weight of calcium oxide; 10-20 parts by weight of magnesium oxide;
3-10 parts by weight of iron;
0.01-1 part by weight of boron;
0.1-3 parts by weight of manganese;
0.5-3 parts by weight of zinc; and,
0.0001-0.001 parts by weight of molybdenum.

2. The composite composition for promoting growth having a natural silica extract and biochar of claim 1, wherein the composition for promoting the activity of Actinomycete includes biochar, a natural silica extract, water-soluble minerals, and chitosan at a ratio of 1:1:1:1.

3. The composite composition for promoting growth having a natural silica extract and biochar of claim 1, wherein the biochar is obtained by pyrolyzing biomass, and may have an average particle size of 20 to 200 micrometers and a porosity of 30 to 80%.

4. The composite composition for promoting growth having a natural silica extract and biochar of claim 1, wherein the natural silica extract is a rice husk extract, and the rice husk extract is prepared through heat treatment.

5. The composite composition for promoting growth having a natural silica extract and biochar of claim 1, further comprising an organic raw material.

6. The composite composition for promoting growth having a natural silica extract and biochar of claim 1, wherein the composite composition includes any one or a plurality selected from a residual pesticide remover, a nutritional additive, a thickener, a surfactant, a stabilizer, an antifoaming agent, a cryoprotectant, and a preservative.
